(19) United States
(12) Patent Application Publication
(10) Pub. No.: US 2004/0173973 A1
(43) Pub. Date: Sep. 9, 2004

(54) Sealing ring

(76) Inventors: Eric Kammerer, Langres (FR); Celine Guillerme, Neuilly L'eveque (FR)

Correspondence Address: HARNESS, DICKEY & PIERCE, P.L.C., P.O. BOX 828, BLOOMFIELD HILLS, MI, 48303, US

(21) Appl. No.: 10/794,713

(22) Filed: Mar. 5, 2004

(30) Foreign Application Priority Data
Mar. 7, 2003 (DE) 103 09 907.7

(51) Int. Cl. F16J 15/32; F01D 11/02

(52) U.S. Cl. 277/549

(57) ABSTRACT

A sealing ring comprising a sealing sleeve that is made of a polymeric material and is essentially L-shaped. A fastening region extends essentially in a radial direction and a sealing region extends essentially in an axial direction. The sealing region surrounds, in sealing manner, a surface of a machine element to be sealed by exerting radial tension. The sealing region has, on the side facing the surface, at least one back-feeding device for conveying a medium to be sealed in the direction of the space to be sealed off. The back-feeding device has a profile with a volumetric delivery that decreases from the space to be sealed off in the direction of the surroundings.

### CROSS-REFERENCE TO RELATED APPLICATIONS

This application claims the benefit of German Patent Application 10309907.7-12, filed Mar. 7, 2003. The disclosure of the above application is incorporated herein by reference.

### FIELD OF THE INVENTION

The invention relates to a sealing ring.

### BACKGROUND OF THE INVENTION

Sealing rings are generally known, for example from DE 199 22 842 A1. Prior-art sealing rings comprise a sealing sleeve made of a polymeric material. The sleeve, when used in the intended manner, as seen in longitudinal cross-section, is essentially L-shaped, has a fastening region extending essentially in radial direction, and a sealing region extending essentially in an axial direction and which surrounds in a sealing manner, by exercising radial tension, the surface of a machine element to be sealed. The element is in the form of a shaft. The sealing region is curved in the direction of the space to be sealed off and, on the side facing the surface, is provided with a back-feeding device to convey the medium to be sealed in the direction of the space to be sealed off.

The back-feeding device, in the prior-art sealing ring, extends from the free end of the sealing sleeve, that faces away from the fastening region, to a microlip which is supported on the surface of the machine element to be sealed. The back-feeding device is in the form of a groove. the geometry of which, from the free end of the sealing sleeve to the microlip, namely in its sealing region, does not change. In this region, the volume of material fed back is constant.

In a bent transition region of the sealing sleeve, from the sealing region to the fastening region, there is provided another groove section, the groove in this section being open in the direction of the surroundings and having no function related to the back-feeding of the medium to be sealed in the direction of the space to be sealed off. This groove section is different from the groove section extending from the free end of the sealing sleeve to the microlip.

### SUMMARY OF THE INVENTION

The object of the invention is to further develop a sealing ring of the aforesaid kind in a manner such that the conveying efficiency along the sealing region is adapted to the amount of medium to be sealed that is to be fed back to the space to be sealed off.

To reach the above objective, the present invention provides a sealing ring comprising a sealing sleeve made of polymeric material which, during its intended use and as seen in longitudinal cross-section, is essentially L-shaped, has a fastening region that extends essentially in radial direction, and a sealing region that extends essentially in axial direction and surrounds in a sealing manner, by exercising radial tension, the surface of a machine element to be sealed. The sealing region on the side facing the surface is provided with at least one back-feeding device for conveying the medium to be sealed in the direction of the space to be sealed off. The back-feeding device has a profile such that the volumetric delivery decreases from the space to be sealed off in the direction of the surroundings.

In this regard, it is advantageous that the conveying efficiency of the back-feeding device is adapted to the amount of medium to be sealed, which is to be fed back to the space to be sealed off, and which is present on the surface of the machine element to be sealed off, in the region of the sealing sleeve. The conveying efficiency of the back-feeding device is greater on the side facing the space to be sealed off than on the side facing the surroundings. Because the geometry of the back-feeding device is adapted to the amount of medium to be sealed and to be returned to the space to be sealed off, the sealing region can, based on the required effectiveness in its partial regions, be made to be particularly efficient. As such, for the sealing ring according to the principles of the present invention, it is not necessary to provide, on the side facing away from the space to be sealed off, a back-feeding device with excessive volumetric delivery and attendant oversized dimensions of the sealing sleeve.

The volumetric delivery decreases, preferably continuously, along the sealing region from the space to be sealed off in the direction of the surroundings. As a result, the volumetric delivery, considered along the sealing region, is proportional to the amount of the medium to be sealed and to be returned to the space to be sealed off. On the side facing the space to be sealed off, the dimensions of the back-feeding device are such that the volumetric delivery is relatively high so that, in this region, the relatively large volume of the medium to be sealed and present in the sealing region can be returned to the space to be sealed off. Along the sealing region in the direction of the surroundings, the amount of medium to be sealed decreases so that, on the side of the sealing region facing the surroundings, only a relatively low volumetric delivery/conveying efficiency is needed to return the small amount of medium to be sealed back to the space to be sealed off.

The back-feeding device can consist of at least one coil-shaped back-feeding groove. Such back-feeding devices are generally known from the prior art. They can be produced in simple and economic manner and they exhibit good use properties during a long service life.

The depth of the back-feeding groove can decrease from the space to be sealed off along the sealing region in the direction of the surroundings. If only one parameter of the sealing sleeve, for example the groove depth, varies along the sealing region, the sealing sleeve and thus the entire sealing ring can be produced in a simple and economic manner. The varying groove depth along the sealing region is sufficient to cause the volumetric delivery to decrease from the space to be sealed off in the direction of the surroundings.

The slope and/or width of the back-feeding groove along the sealing region can be essentially constant. This simplifies the fabrication of the sealing sleeve.

The slope and/or width of the back-feeding groove can also vary along the sealing region. In this case, the slope and/or width of the back-feeding groove preferably decreases from the fastening region to the free end of the sealing sleeve. In this manner, the action of the decreasing groove depth is reinforced. At the same time, the entry of dust/dirt from the surroundings is prevented.

A ratio of the largest groove depth to the smallest groove depth in the sealing region of 2 to 6 and preferably of 4 was found advantageous for most uses. For such dimension ratios, the specific conveying efficiency/specific volumetric delivery, based on the amount of medium to be sealed and to be fed back, is constant along the entire sealing region.

The sealing region can be curved axially in the direction of the surroundings, starting from the fastening flange. In particular, the sealing ring with the sealing sleeve according to the invention is especially advantageous for such a design. Sealing sleeves curved in the direction of the surroundings have the advantage that radial pressure of the sealing sleeve against the shaft can be controlled at the free end of the sealing sleeve. This results in increased sealing efficacy and prolonged service life. An auxiliary seal can be provided at the free end of the sealing sleeve. Such a seal is an effective barrier against dust/dirt, has small dimensions, and can be produced in simple and economic manner.

During installation into the annular gap between the shaft and the receiving opening, the sealing sleeve is, as a result of the installation, deformed to its proper shape. The installation of the sealing sleeve does not require a mounting tool. Installation errors for a sleeve of such design are reduced to a minimum.

The initial radial tension at which the sealing region surrounds, in a sealing manner, the surface of the machine element to be sealed is different when viewed in longitudinal cross-section, in that the sealing region on the side facing the fastening region exhibits higher contact pressure than in the region of its free end. This would be particularly true if the structure of the back-feeding device were the same along the entire sealing region.

To increase the radial pressure, particularly of the free end of the sealing region, against the surface of the machine element to be sealed and thus to achieve a radial tension equal to that on the side axially facing the fastening region, it is necessary to minimize weakening of the material in this region, for example by the back-feeding device. This can be achieved, for example, by reducing the groove depth from the side facing the fastening region along the sealing region in the direction of the free end of the sealing region, while leaving the other dimensions unchanged. With such a design, not only is the specific conveying efficiency along the sealing region the same, but also the radial tension at which the sealing region surrounds the surface of the machine element to be sealed.

The sealing sleeve can be made, for example, of a polytetrafluoroethylene [PTFE] compound. PTFE is resistant to most media to be sealed and shows relatively negligible low wear during the entire service life of the sealing ring

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 depicts a first principle of the invention in longitudinal cross-section, wherein the sealing sleeve is curved in the direction of the surroundings;

FIG. 2 shows the sealing region of the sealing sleeve of FIG. 1;

FIG. 3 shows a second principle of the invention with a sealing sleeve of different design compared to that of FIG. 1, wherein the sealing sleeve is curved in the direction of the surroundings;

FIG. 4 shows the sealing region of the sealing sleeve of FIG. 3;

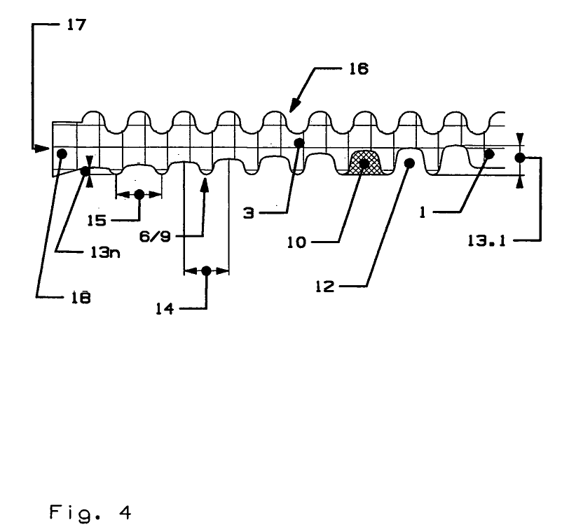

FIG. 5 shows a third principle of the invention with the slope and/or width of the back-feeding groove varying along the sealing region, wherein the sealing sleeve is curved in the direction of the surroundings; and

FIG. 6 shows a housing lid into which the sealing ring of the invention is integrated.

### DETAILED DESCRIPTION OF THE PREFERRED EMBODIMENTS

The following description of the preferred embodiment(s) is merely exemplary in nature and is in no way intended to limit the invention, its application, or uses.

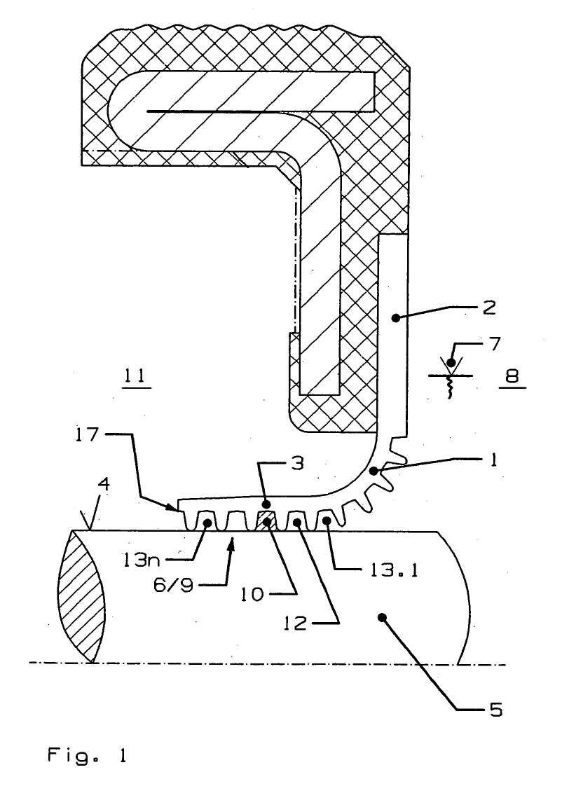

FIGS. 1 to 3 show a sealing ring according to a principle of the present invention during its intended use.

In the embodiments shown here, a machine element 5 to be sealed consists of a shaft.

The sealing rings shown in FIGS. 1 to 3 comprise a sealing sleeve 1 made of a polymeric material which, in the embodiments shown here, is a PTFE compound. Viewed in longitudinal cross-section, the sealing sleeves are L-shaped and comprise a fastening region 2 extending essentially in the radial direction, and a sealing region 3 extending essentially in the axial direction. In the embodiments shown here, fastening region 2 and sealing region 3 merge into one another forming a single unit and are made of the same material.

Sealing region 3 of sealing sleeve 1 surrounds, with a sealing tension, surface 4 of the machine element 5 to be sealed. On the side of sealing region 3 that radially faces surface 4 is disposed a back-feeding device 6 in the form of a coil-shaped back-feeding groove 12 for the purpose of conveying a medium 7 that is to be sealed in the direction of a space 8 to be sealed off.

In both embodiments shown here, sealing sleeve 1 is curved axially in the direction of surroundings 11. It is crucial that the profile 9 of back-feeding device 6 have a volumetric delivery 10/conveying efficiency such that the delivery decreases from the space 8 to be sealed off in the direction of surroundings 11. The specific conveying efficiency along the entire sealing region is thus constant. The conveying efficiency of back-feeding device 6 is adapted to the amount of medium to be sealed that is to be returned to the space 8 to be sealed off.

In the embodiments shown here, both slope 14 and width 15 of the back-feeding groove along sealing region 3 are essentially constant. The only variable in reaching a constant specific conveying efficiency is the groove depth 13. Groove depth 13 varies along sealing region 3 in a manner such that the depth of back-feeding groove 12 decreases from space 8 to be sealed off along sealing region 3 in the direction of surroundings 11. In the embodiments shown here, the ratio of the greatest groove depth is 13.1 on the side facing space 8 to be sealed off to the smallest groove depth 13.n in the sealing region amounts to 4.

In FIG. 1 is shown a first embodiment of the sealing ring of the invention. Sealing sleeve 1 has a back-feeding groove 12 of profile 9 only on the surface 4 to be sealed of machine element 5. On the side of sealing sleeve 1 facing away from surface 4, the sleeve is flat. Back-feeding groove 12, seen in longitudinal cross-section, has essentially the shape of a trapeze.

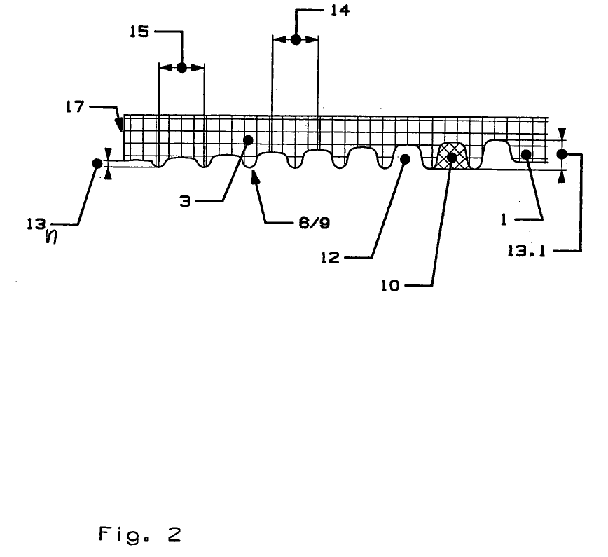

FIG. 2 shows a magnification of sealing region 3 of sealing sleeve 1.

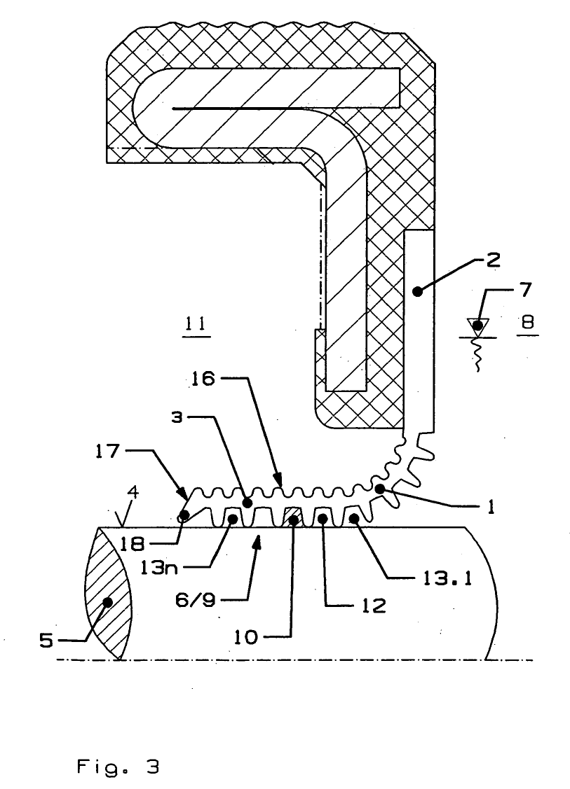

FIG. 3 shows a second embodiment of the sealing ring of the invention which differs from the sealing ring of FIG. 1 only by a differently designed sealing sleeve 1.

Unlike sealing sleeve 1 of FIG. 1, sealing sleeve 1 of FIG. 3 is provided with a second profile 16 on the side radially facing away from surface 4. As a rule, this second profile 16 is less deep and has smaller divisions than the first profile 9.

In addition, free end 17 of sealing sleeve 1 is provided with an auxiliary seal 18 oriented in the direction of surroundings 11, the seal keeping contamination from surroundings 11 out of sealing region 3. Auxiliary seal 18 merges into the sealing sleeve forming a single unit, the two-components being made of the same material.

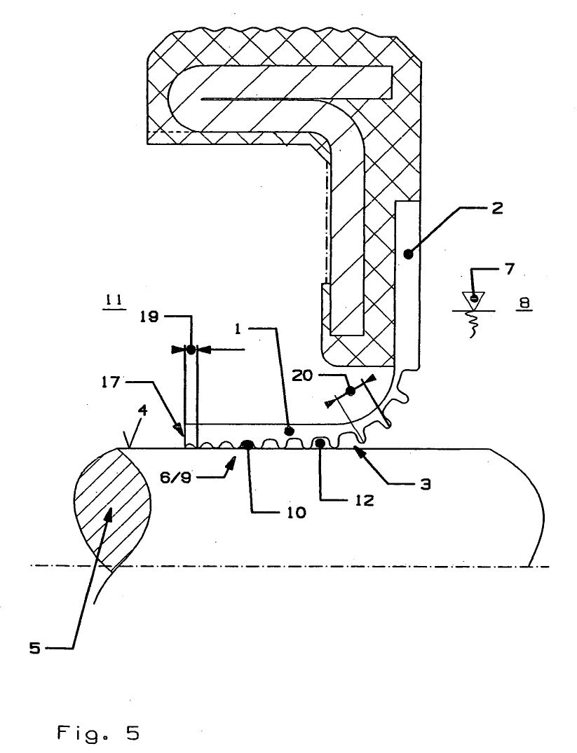

FIG. 5 shows a third embodiment in which the width and/or slope 19/20 of back-feeding groove 12 varies along sealing region 3.

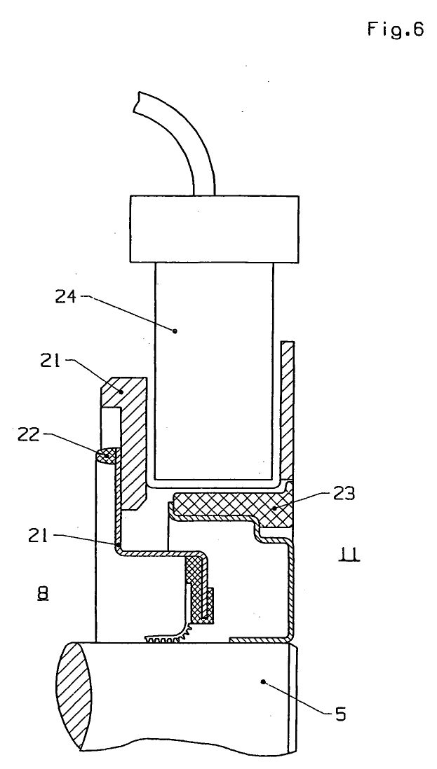

FIG. 6 depicts a housing lid 21 into which the sealing ring of the invention is integrated. The static seal on the housing lid 21 bears reference number 22, the measured value transmitter/multipole wheel the reference number 23 and the measured value receiver/sensor the reference number 24.

The embodiments shown here are not meant to limit the scope of the invention. In particular, the back-feeding device 6 can be of a coiled, screw-like or concentric design, with one or more turns, and the back-feeding grooves, viewed in longitudinal cross-section can have the shape of, for example, a trapeze, triangle, saw tooth or caterpillar track. Back-feeding groove 12 can be shut off, for example by a partition and/or a circular projection. Sleeve 1 rather than consisting of a PTFE compound can be made of other suitable materials.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A sealing ring comprising:
a sealing sleeve made of a polymeric material, the sealing sleeve including an essentially L-shape with a fastening region that extends essentially in a radial direction and a sealing region that extends essentially in an axial direction, the sealing sleeve surrounding in sealing manner a surface of a machine element to be sealed by radial tension;
the sealing region having on a side facing the surface at least one back-feeding device for conveying a medium to be sealed in a direction of a space to be sealed off, the back-feeding device having a profile and a volumetric delivery that decreases from the space to be sealed off in the direction of the surroundings.

2. The sealing ring according to claim 1, characterized in that the volumetric delivery continuously decreases along the sealing region from the sealing space to be sealed off in the direction of the surroundings.

3. The sealing ring according to claim 1, characterized in that the volumetric delivery, is proportional to the amount of the medium to be sealed, and which is to be conveyed back to the space to be sealed off.

4. The sealing ring according to claim 1, characterized in that the back-feeding device comprises at least one coil-shaped back-feeding groove.

5. The sealing ring according to claim 4, characterized in that a depth of the back-feeding groove decreases from the space to be sealed off along the sealing region in the direction of the surroundings.

6. The sealing ring according to claim 4, characterized in that a slope of the back-feeding groove along the sealing region is essentially constant.

7. The sealing ring according to claim 4, characterized in that a width of the back-feeding groove along the sealing region is essentially constant.

8. The sealing ring according to claim 4, characterized in that a ratio of the greatest groove depth (13.1) to the smallest groove depth (13.n) in the sealing region is in the range of 2 to 6.

9. The sealing ring according to claim 4, characterized in that a width and/or slope of the back-feeding groove varies along the sealing region.

10. The sealing ring according to claim 1, characterized in that the sealing region is curved axially from the fastening region in the direction of the surroundings.

11. The sealing ring according to claim 1, characterized in that the polymeric material comprises a PTFE compound.

12. A housing lid comprising:
a sealing ring according to claim 1, the sealing ring being integrated into the housing lid.
